(19) United States
(12) Patent Application Publication
(10) Pub. No.: US 2025/0050297 A1
(43) Pub. Date: Feb. 13, 2025

(54) LOOP COMBUSTION PLANT AND METHOD COMPRISING A CYCLONE AIR REACTOR

(71) Applicants: IFP ENERGIES NOUVELLES, RUEIL-MALMAISON (FR); TOTALENERGIES ONETECH, COURBEVOIE (FR)

(72) Inventors: Catherine LAROCHE, Rueil-Malmaison Cedex (FR); Florent GUILLOU, Rueil-Malmaison Cedex (FR); Sina TEBIANIAN, Rueil-Malmaison Cedex (FR)

(73) Assignees: IFP ENERGIES NOUVELLES, RUEIL-MALMAISON (FR); TOTALENERGIES ONETECH, COURBEVOIE (FR)

(21) Appl. No.: 18/720,497

(22) PCT Filed: Dec. 7, 2022
(86) PCT No.: PCT/EP2022/084839

§ 371 Date: Jun. 14, 2024

(30) Foreign Application Priority Data
Dec. 17, 2021 (FR) FR2113898

(51) Int. Cl. B01J 8/18; B01J 8/00; B01J 8/26; C01B 3/02; C10J 3/46; C10J 3/48

(52) U.S. Cl. CPC B01J 8/1827; B01J 8/0055; B01J 8/1881; B01J 8/26; C01B 3/02; C10J 3/463; C10J 3/487; B01J 2208/00769; C10J 2200/15; C10J 2300/0916; C10J 2300/093; C10J 2300/0943; C10J 2300/1838

(57) ABSTRACT

The present invention relates to a novel CLC plant and to a novel CLC method employing a cyclone oxidation reactor to oxidize the oxygen carrier.

### TECHNICAL FIELD

The present invention relates to the field of chemical looping combustion (“CLC”) redox of hydrocarbon feedstocks in a fluidized bed to produce energy, syngas and/or hydrogen. In particular, the present invention relates to a novel CLC plant and method wherein the oxidation of the oxygen carrier is performed in a cyclone reactor.

### PRIOR ART

A CLC method consists in carrying out redox reactions of an active mass, typically a metal oxide, also referred to as solid-state oxygen carrier or oxygen carrier, to break down the combustion reaction into two successive reactions: a first reaction of oxidation of the oxygen carrier in contact with an oxidizing gas, typically air, and a second reaction of reduction of the oxygen carrier in contact with the feedstock that is to be combusted. The CLC method can be likened to oxy-combustion with the key difference that the combustion is not fed with a dedicated stream of pure oxygen, as it is in oxy-combustion, but with the oxygen carrier serving to transport oxygen.

Typically, the particles are oxidized in contact with an oxidizing gas, e.g. air, in a first reaction zone, called oxidation reactor or air reactor. They are then transported to a second reaction zone called combustion reactor or fuel reactor where they are brought into contact with a solid, liquid or gaseous hydrocarbon feedstock that is to be combusted. The oxygen transported by the particles of oxygen carrier feeds the combustion of the feedstock in the fuel reactor. This results in a gaseous effluent formed by the combustion of the feedstock and a stream of reduced particles. The particles are returned to the air reactor to be re-oxidized therein, thus closing the loop.

CLC methods are known in the field of energy production, gas turbines, boilers and furnaces, especially for the oil, glass and cement industry.

In particular, the CLC method makes it possible to produce energy (steam, electricity, and the like) by recuperating the heat given off by the combustion reactions while facilitating the capture of the carbon dioxide (CO₂) emitted during the combustion by virtue of the production of flue gases rich in CO₂. In the CLC method, the combustion flue gases produced in the fuel reactor are effectively free of oxygen and of nitrogen. The CO₂ can effectively be captured after condensation of the steam and compression of the flue gases, and it can then be stored, for example in geological formations, or used as a reagent in other processes, or else be valorized, for example by employing it for improving the output of oil operations in enhanced oil recovery (EOR) or enhanced gas recovery (EGR) processes.

The CLC method can also make possible the production of syngas, indeed even of hydrogen, by controlling the operating conditions of the combustion (the stoichiometric ratio and the temperature) and by carrying out the required purifications downstream of the combustion process. This mode of combustion may also enable the production of a stream very rich in nitrogen, which is the depleted air obtained on conclusion of the oxidation of the active mass in the air reactor. Depending on the degree of purity achieved, this nitrogen stream can be valorized in various applications, in particular in the field of the oil industry. It can, for example, be used in refineries as inert gas in various oil refining processes or for the treatment of production waters, or as gas injected into the subsoil in EOR processes.

In a context of increasing global energy demand, the CLC method thus provides an attractive solution for capturing CO₂ for the purpose of sequestering it or valorizing it in other processes, so as to limit the emission of environmentally detrimental greenhouse gases.

The oxygen carrier is a solid material presented in the form of particles that can be fluidized, with a typical particle size ranging between 50 μm and 500 μm. The particles are brought into contact, in the reaction zones, with either the oxidizing gas or the feedstock, in the form of high-temperature fluidized beds, and are generally transported from one zone to another in fluidized form. The circulating fluidized bed technology is generally used to make possible the continuous passage of the oxygen carrier from its oxidized state in the air reactor to its reduced state in the fuel reactor.

In a CLC method, the air and fuel reactors therefore each have gas and solid phases that form what may be an upwardly moving gas/solid mixture. In the air reactor in particular, this mixture generally moves at high speed (several meters per second, for example between 2 m/s and 5 m/s, for the superficial velocity of the gas), the air reactor typically being a reactor of riser type, forming a substantially elongate and vertical pipe (for example of a diameter ranging between 1 m and 6 m for a height ranging between 10 m and 30 m), and operating as a dilute fluidized bed (rapid fluidization or pneumatic transportation regime).

On leaving the air reactor, the gas/solid mixture is separated in a cyclone in order to separate the oxygen carrier from the depleted air. Cyclones or other gas/solid separation devices are also used at the outlet of the fuel reactor in order to separate the oxygen carrier from the combustion flue gases.

FIG. 1 represents a CLC plant according to the prior art. The oxygen carrier in its reduced form 400 is introduced into the air reactor 1000 and brought into contact with an air stream 100. The solid-state oxygen carrier reacts with the oxygen in the air to form a gas/solid mixture 101 made up of oxidized solid-state oxygen carrier and depleted air, i.e. air of which the oxygen concentration has been reduced following reaction with the oxygen carrier. The mixture 101 is introduced into a cyclone 3001 which produces a gaseous effluent 110 essentially containing depleted air and a stream of solid 102 essentially containing the oxygen carrier in its oxidized form. This stream of solid 102 is introduced into the fuel reactor 2000 where it is brought into contact with a hydrocarbon feedstock 200 within a fluidized bed, typically by means of a fluidizing gas 300. Depending on the feedstock used, the fluidizing gas 300 may contribute to the gasification of the hydrocarbon feedstock 200, particularly if this feedstock is solid or liquid. The fluidizing gas 300 may be useful, but is not indispensable, if the hydrocarbon feedstock 200 introduced into the reactor is gaseous. The feedstock in gaseous form, which may be a gaseous hydrocarbon feedstock 200 introduced into the reactor 2000 or the product of the gasification of a solid or liquid hydrocarbon feedstock 200, reacts with the oxygen contained in the oxygen carrier. This results in a gas/solid mixture 301 containing the reduced oxygen carrier, flue gases resulting from the combustion of the feedstock and of the fluidizing gas, and possibly gaseous or solid unburnt matter. This gas/solid mixture 301 is separated in a gas/solid separation device 3002, typically a cyclone, into a solid stream essentially containing the reduced oxygen carrier 400 and a gaseous mixture 310 containing the combustion flue gases and the fluidizing gas.

The air and fuel reactors and the associated gas/solid separation devices are therefore key elements in a CLC plant and method. The function performed by each is essential to the CLC operation, and any improvement made to these elements may considerably increase the attractiveness of this energy production technology that enables CO₂ capture.

### OBJECTIVES AND SUMMARY OF THE INVENTION

In this context, the present invention seeks to address the general problem of producing energy by means of burning a hydrocarbon feedstock that incorporates CO₂ capture, and in particular seeks to provide a CLC plant that is more compact than a conventional CLC plant as described hereinabove, and therefore potentially represents a lower capital expenditure (CAPEX). Another objective of the present invention is to enable existing industrial combustion facilities, for example those using a boiler, to be converted into chemical looping combustion units.

In this context, and in order to achieve at least one of the above-mentioned objectives, amongst others, the present invention in a first aspect proposes a CLC plant for the combustion of a hydrocarbon feedstock using a solid-state oxygen carrier in the form of particles, comprising at least:
a reduction reactor configured to operate as a fluidized bed and perform the combustion of said hydrocarbon feedstock in contact with said oxygen carrier;
at least one cyclone oxidation reactor configured to oxidize said reduced oxygen carrier coming from said reduction reactor by bringing it into contact with an oxidizing gas and to separate said oxidized oxygen carrier from said oxygen-depleted oxidizing gas;
lines for circulating said oxygen carrier between said reduction reactor and said at least one cyclone oxidation reactor.

According to one or more embodiments, said at least one cyclone oxidation reactor comprises:
a cylindrical-conical chamber comprising a cylindrical upper portion surmounting an inverted frustoconical lower portion;
an inlet pipe carrying a gaseous mixture containing particles of the oxygen carrier and oxidizing gas, said inlet pipe being equipped with a main injection duct for the injection of oxidizing gas and said inlet pipe opening into said cylindrical upper portion;
an outlet pipe for a stream of oxygen-depleted gas, this pipe being positioned at the top of the cylindrical upper portion;
a discharge pipe for discharging a stream of particles of oxygen carrier, this pipe being positioned at the bottom of the inverted frustoconical lower portion.

According to one or more embodiments, the plant comprises several cyclone oxidation reactors configured to operate in series and/or in parallel.

According to one or more embodiments, the plant comprises two cyclone oxidation reactors configured to operate in series.

According to one or more embodiments, the plant comprises at least two cyclone oxidation reactors configured to operate in series, and the outlet pipe of a second cyclone oxidation reactor positioned downstream of a first cyclone oxidation reactor is connected to the inlet pipe of said first cyclone oxidation reactor to form the main injection duct for the injection of oxidizing gas fed to said first cyclone oxidation reactor.

According to one or more embodiments, the inlet pipe of said at least one cyclone oxidation reactor is equipped with at least one secondary oxidizing-gas injection duct, preferably situated on a lower wall of said inlet pipe.

According to one or more embodiments, the plant comprises a cyclone positioned downstream of and connected directly to said reduction reactor, configured to receive a gas/solid mixture coming from said reduction reactor and to perform separation between the reduced oxygen carrier and combustion flue gases, said cyclone comprising an outlet pipe for the reduced oxygen carrier, this pipe being connected to said at least one cyclone oxidation reactor.

According to one or more embodiments, the plant comprises:
a solid/solid separation device positioned downstream of and connected directly to said reduction reactor, said solid/solid separation device being configured to operate as a fluidized bed, to receive a gas/solid mixture coming from said reduction reactor, and to perform separation between the particles of the reduced oxygen carrier and unburnt particles contained in said gas/solid mixture, and
at least one cyclone positioned downstream of said solid/solid separation device and configured to receive a stream of gas containing said unburnt particles and to perform separation between said unburnt particles and combustion flue gases, said cyclone preferably comprising an outlet pipe for said unburnt particles, which pipe is connected to said reduction reactor.

The present invention in another aspect proposes a CLC method for the combustion of a hydrocarbon feedstock using a solid-state oxygen carrier in the form of particles, wherein:
the hydrocarbon feedstock is burnt by bringing it into contact with the oxygen carrier in a reduction reactor operating as a fluidized bed;
the oxygen carrier that has passed through the reduction reactor is oxidized by bringing it into contact with an oxidizing gas, preferably air, in at least one cyclone oxidation reactor, and said oxidized oxygen carrier and the oxygen-depleted oxidizing gas are separated in said cyclone oxidation reactor before said oxidized oxygen carrier is returned to the reduction reactor.

According to one or more embodiments:
an oxidizing gas and the oxygen carrier coming from the reduction reactor are mixed in an inlet pipe of said at least one cyclone oxidation reactor;
said gaseous mixture containing the oxygen carrier is sent into a cylindrical upper portion of a cylindrical-conical chamber of said cyclone oxidation reactor, said cylindrical-conical chamber comprising the cylindrical upper portion surmounting an inverted frustoconical lower portion;
said oxygen carrier is oxidized in contact with the oxidizing gas and the oxidized oxygen carrier and the oxygen-depleted oxidizing gas are separated within said cylindrical-conical chamber;
said oxygen-depleted oxidizing gas is discharged via an outlet pipe positioned at the top of the cylindrical upper portion;
and a stream of oxidized oxygen carrier is discharged via a discharge pipe positioned at the bottom of the inverted frustoconical lower portion.

According to one or more embodiments, the oxygen carrier coming from the reduction reactor is oxidized in two cyclone oxidation reactors operating in series and/or in parallel.

According to one or more embodiments, the oxygen-depleted oxidizing gas discharged via the outlet duct of a second cyclone oxidation reactor positioned downstream of a first cyclone oxidation reactor is used to form the gaseous mixture in the inlet pipe of said first cyclone oxidation reactor and to oxidize the oxygen carrier coming from the reduction reactor within said first cyclone oxidation reactor.

According to one or more embodiments, a gas/solid mixture coming from the reduction reactor is sent to a cyclone positioned downstream of and connected directly to said reduction reactor in order to separate the reduced oxygen carrier from the combustion flue gases contained in said gas/solid mixture, and the reduced oxygen carrier is sent to said at least one cyclone oxidation reactor.

According to one or more embodiments, the hydrocarbon feedstock is a solid feedstock in the form of particles, preferably selected from the list consisting of coal, coke, petcoke, biomass, oil sands and household waste, and:
a gas/solid mixture coming from the reduction reactor is sent to a solid/solid separation device connected directly to said reduction reactor and operating as a fluidized bed in order to separate the reduced oxygen carrier from the unburnt particles contained in said gas/solid mixture;
a stream of gas coming from the solid/solid separator and containing said unburnt particles is sent to at least one cyclone in order to separate said unburnt particles from the combustion flue gases;
the reduced oxygen carrier is sent to said at least one cyclone oxidation reactor, preferably by means of an L-ported valve;
optionally, said unburnt particles are sent to said reduction reactor.

According to one or more embodiments, the residence time of the oxygen carrier in said at least one oxidation reactor is less than or equal to 30 seconds.

Other subjects and advantages of the invention will become apparent on reading the description which follows of particular exemplary embodiments of the invention, which are given as nonlimiting examples, the description being made with reference to the appended figures described below.

### LIST OF FIGURES

FIG. 1, already described, schematically depicts a CLC plant according to the prior art.

FIG. 2 is a diagram of the CLC plant according to one or more embodiments of the present invention comprising a cyclone oxidation reactor.

FIG. 3 is a diagram of the CLC plant according to one or more embodiments of the present invention comprising two successive cyclone oxidation reactors.

FIG. 4 is a diagram of the CLC plant according to one or more embodiments of the present invention comprising two successive cyclone oxidation reactors, the first of which is fed with an oxygen-depleted oxidizing gas coming from the second cyclone oxidation reactor.

FIG. 5 is a diagram of the CLC plant according to one or more embodiments of the present invention suitable for the combustion of a solid hydrocarbon feedstock, comprising a cyclone oxidation reactor and a solid/solid separation device at the outlet of the fuel reactor.

In the figures, the same references denote identical or analogous elements.

### DESCRIPTION OF THE EMBODIMENTS

The present invention proposes a novel CLC plant and a novel CLC method for the combustion of a hydrocarbon feedstock where the oxidation reactor has a cyclone structure and is referred to in this description as a cyclone oxidation reactor, having both the function of oxidizing the particles of the oxygen carrier during the CLC method and the function of separating the oxidized particles of the carrier from the gas that was used to oxidize them, before the particles are sent once again to the reduction reactor. Such a cyclone oxidation reactor advantageously makes it possible to combine the functions performed in a conventional CLC plant by two different devices: the oxidation reactor which operates as a fluidized bed and is generally a riser, and the cyclone at the outlet of the oxidation reactor which separates the carrier particles from the depleted air. The CLC plant according to the invention is thus more compact, and the capital expenditure is lower. The method according to the invention is notably able to employ the plant according to any one of the variants or combinations of variants described hereinafter.

The invention relates to a CLC plant and method as described in greater detail below. However, it would not constitute a departure from the scope of the invention if the cyclone oxidation reactor described in respect of the CLC plant/method were used in other chemical-looping redox plants/methods using circulating fluidized bed technology, such as chemical looping reforming (CLR) plants/methods, or chemical looping oxygen uncoupling (CLOU) plants/methods.

In the present description, reference is made to chemical looping redox plants/methods (CLC, CLR, CLOU), particularly CLC plants/methods operating as a circulating fluidized bed, which is to say under conditions in which the solid-state oxygen carrier in the form of particles is fluidized so that it can be transported and circulated in the plant.

In the present description, the expressions “solid-state oxygen carrier”, “oxygen carrier”, “oxygen transporting material”, “active redox mass” or its abbreviated form “active mass” are all equivalent. The redox mass is said to be active in connection with its reactive capacities, in the sense that it is capable of acting as oxygen transporter in the CLC method by capturing and releasing oxygen.

It should be noted that, in general, the terms oxidation and reduction are used in relation to the oxidized or reduced state of the oxygen carrier, respectively. The cyclone oxidation reactor, also called cyclone air reactor, is the reactor in which the oxygen carrier is oxidized and separated from the oxidizing gas used to oxidize it, and the reduction reactor, also called fuel reactor or combustion reactor, is the reactor in which the oxygen carrier is reduced. The reduction reactor operates as a fluidized bed, the cyclone oxidation reactor operates like a conventional cyclone from a hydrodynamic standpoint, and the oxygen carrier circulates between the cyclone oxidation reactor and the reduction reactor. The circulating fluidized bed technology is used to make possible the continuous passage of the oxygen carrier from its oxidized state in the cyclone oxidation reactor to its reduced state in the reduction reactor.

Throughout the rest of the description and in the claims, the positions (“bottom”, “top”, “above”, “below”, “horizontal”, “vertical”, “lower half”, etc.) of the various elements are defined relative to the reactors and various devices of the plant in their operating position.

In the present description, the term “to comprise” is synonymous with (means the same thing as) “to include” and “to contain”, and is inclusive or open-ended and does not exclude other elements that are not mentioned. It is understood that the term “to comprise” includes the exclusive and closed term “to consist of”.

In the present description, the expression “ranging between . . . and . . . ” means that the limiting values of the interval are included in the described range of values, unless otherwise specified.

In addition, in the present description, the terms “essentially” or “substantially” correspond to an approximation of ±5%, preferably of ±1%, very preferably of ±0.5%. For example, an effluent essentially comprising or consisting of compounds A corresponds to an effluent comprising at least 95% by weight of compounds A.

Some embodiments of the CLC method and plant are described in detail hereinafter. Numerous specific details are presented in order to provide a deeper understanding of the invention. However, it will be apparent to those skilled in the art that the CLC plant and method can be utilized without all of these specific details. In other cases, well-known characteristics have not been described in detail in order to avoid unnecessarily complicating the description.

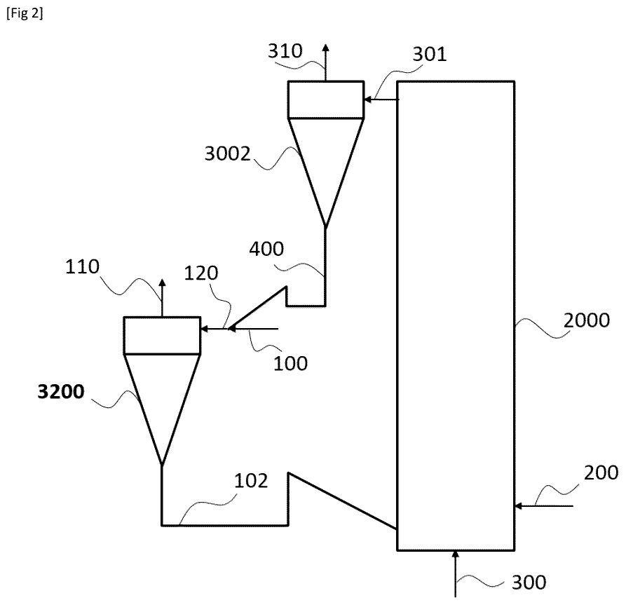

With reference to FIG. 2, the CLC plant according to one or more embodiments of the present invention comprises a reduction reactor 2000 configured to operate as a fluidized bed and to perform combustion of a hydrocarbon feedstock 200 in contact with an oxygen carrier in the form of particles 102, in its reduced state. The plant also comprises a cyclone oxidation reactor 3200 configured, on the one hand, to oxidize the reduced oxygen carrier 400 coming from the reduction reactor by bringing it into contact with an oxidizing gas 100 and, on the other hand, to separate the oxidized oxygen carrier from the oxygen-depleted oxidizing gas 110. In other words, the cyclone oxidation reactor simultaneously performs two functions in a single device: the oxidation of the oxygen carrier and the separation of the oxygen carrier from the oxidizing gas. The plant also comprises lines for circulating the oxygen carrier between the reduction reaction 2000 and the cyclone oxidation reactor 3200.

The oxygen carrier 400 that has passed through the reduction reactor 2000 is oxidized by bringing it into contact with the oxidizing gas 100 within the cyclone oxidation reactor 3200, and the oxidized oxygen carrier and the oxygen-depleted oxidizing gas are separated in said cyclone oxidation reactor 3200 before the oxidized oxygen carrier is returned to the reduction reactor 2000. The cyclone oxidation reactor 3200 is detailed later on in the description after the description of the reduction reactor 2000.

For the sake of simplicity, the representation of FIG. 2 does not comprise all of the equipment which may form part of the CLC plant. Devices other than those depicted, notably for solid/gas separation, solid/solid separation, exchange of heat, pressurizing, sealing against gas between the reactors, i.e. sealing oxidizing atmospheres off from reducing atmospheres (e.g.: traps), storage of the solid, control of streams of solids (e.g. mechanical or pneumatic valves) or any recirculation of material around the oxidation and combustion reactors, may also be employed.

In the reduction reactor 2000, the hydrocarbon feedstock 200 is placed in contact, co-currentwise, with the oxygen carrier in the form of particles 102 so as to perform the combustion of said feedstock by reduction of the oxygen carrier.

The oxidation carrier MₓO_{y}, M representing a metal, is reduced to the MₓO_{y-2n-m/2} state by means of the CₙHₘ hydrocarbon feedstock, which is correspondingly oxidized to give CO₂ and H₂O, according to the reaction (1) below, or optionally to give a CO+H₂ mixture, according to the proportions used.

CₙHₘ+MₓO_{y}→nCO₂+m/2H₂O+MₓO_{y-2n-m/2} [Math 1]

The complete combustion of the hydrocarbon feedstock is generally targeted.

The combustion of the feedstock 200 in contact with the oxygen carrier is carried out at a temperature generally ranging between 600° C. and 1400° C., preferentially between 800° C. and 1000° C. The contact time varies according to the type of combustible feedstock used. It typically varies between 1 second and 20 minutes, for example preferably between 1 minute and 10 minutes, and more preferentially between 1 minute and 8 minutes for a solid or liquid feedstock, and for example preferably from 1 to 20 seconds for a gaseous feedstock.

The hydrocarbon feedstocks (or fuels) processed can be solid, gaseous or liquid hydrocarbon feedstocks, and are preferably solid or gaseous feedstocks. The solid feedstocks can be selected from coal, coke, petcoke, biomass, oil sands, solid tar (or deasphalting tar (or pitch)) and household waste. The gaseous feedstocks are preferably essentially made up of methane, for example natural gas or a biogas. The liquid feedstocks can be selected from petroleum, bitumen, diesel, gasoline and pitch. The tars can be likened to a solid or liquid feedstock depending on their melting point. Preferably, the hydrocarbon feedstock processed is a solid or gaseous feedstock, as stated above.

The reduction reactor operates as a fluidized bed. It comprises at least one system for injection of a fluidization gas 300. Depending on the hydrocarbon feedstock 200 used, the fluidizing gas 300 may contribute to the gasification of the hydrocarbon feedstock, particularly if this feedstock is solid or liquid. In the reduction reactor 2000, the fluidization gas can be CO₂, which can be CO₂ produced during the combustion and recycled, or steam.

The reduction reactor 2000 is preferably configured to comprise a dense fluidized bed. As a preference, the superficial velocity of the gas in the dense fluidized bed of the reduction reactor, which is also referred to here as the operational superficial gas velocity U_{g}, is comprised between 0.1 m/s and 3 m/s, preferably between 0.3 m/s and 2 m/s.

By way of example, the reduction reactor 2000 may have a diameter D_{R} ranging between 1 m and 10 m. As a preference, the reduction reactor has a ratio of height H_{R} to diameter D_{R} ranging between 0.5 and 8, preferably ranging between 1 and 5, and even more preferentially ranging between 2 and 4. The same can be said of the ratio of the height of the dense fluidized bed in the reactor to the diameter of the reactor.

What must be understood by a dense fluidized bed is a gas/solid fluidized bed operating in the bubbling regime (also called a bubbling bed) or in the turbulent regime. The fraction by volume of solid in such a dense fluidized bed is generally between 0.25 and 0.50.

In instances where it is solid hydrocarbon feedstocks that are burnt, a sufficiently long contact time for the contact of the feedstock with the particles of the oxygen carrier is generally needed in order to tend toward complete combustion, and entails a first phase of gasifying the solid feedstock, followed by combustion of the gasified feedstock. The two phases may be carried out in the dense fluidized bed of the reduction reactor. In another configuration, the first phase may be carried out in the dense fluidized bed of the reduction reactor, and the second phase may be carried out in another combustion zone, for example within the same reactor in a zone surmounting the dense bed and operating as a dilute fluidized bed or in a separate reactor that receives the gasified feedstock and brings it into contact with the oxygen carrier within a dense or dilute fluidized bed.

The reduction reactor 2000 may thus be configured to comprise a dilute fluidized bed.

What must be understood by a dilute fluidized bed is a gas/solid fluidized bed operating in the rapid fluidization regime or in the pneumatic conveying regime. The fraction by volume of solid is generally less than 0.25.

In the case of the chemical looping combustion of gaseous feedstocks, for example, as the contact time required for contact between the oxygen carrier and the feedstock is less than in the case of solid or liquid feedstocks, a riser-type reactor or reactor part, forming a substantially elongate and vertical duct and operating as a dilute fluidized bed may be sufficient to carry out the combustion of the feedstock and convey the particles.

In the reduction reactor or reactor part that is operating as a dilute fluidized bed, the velocity is preferably greater than 3 m/s and less than 30 m/s, more preferentially ranging between 5 m/s and 15 m/s, so as to facilitate the conveying of all of the particles while at the same time minimizing pressure drops so as to optimize the energy efficiency of the process.

The geometry of the reduction reactor may be parallelepipedal, typically a rectangular parallelepiped, cylindrical or any other three-dimensional geometry preferably comprising a symmetry of revolution. The term “cylindrical” refers to a cylinder of revolution. For example, the reduction reactor is cylindrical or has a rectangular parallelepipedal shape. In this latter instance, the diameter D_{R} of the reactor must be understood as meaning an equivalent diameter (equivalent passage cross section).

The materials used to construct the reactor and its constituent elements (inlet(s), discharge point(s), outlet(s), and the like) can be selected from refractory materials, for example of refractory concrete, refractory brick or ceramic type, high temperature steels, for example of Hastelloy®, Incoloy®, Inconel® or Manaurite® type, or conventional steels, for example of stainless steel or carbon steel type, combined with refractory materials or combined with cooling means, such as tubes in which a heat-exchange fluid circulates.

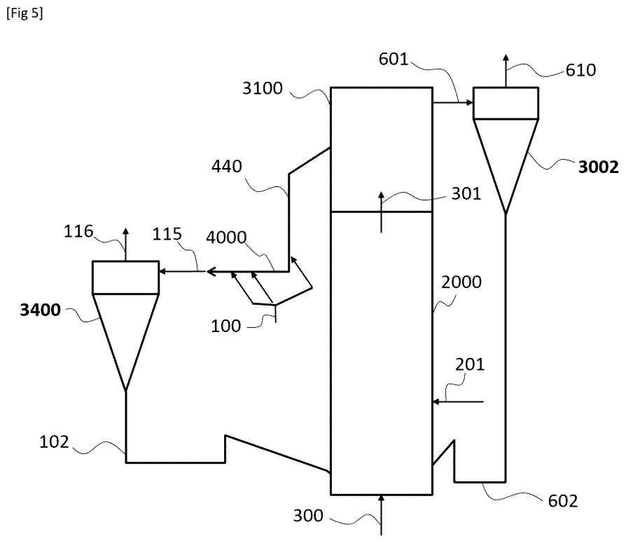

A gas/solid mixture 301 comprising the gases resulting from the combustion, also referred to in the present description as combustion flue gases, and the particles of the oxygen carrier is discharged at the top of the reduction reactor 2000. A gas/solid separation system of cyclone type 3002, comprising one or more cyclones in series and/or in parallel, is positioned downstream of and connected directly, i.e. without any other intermediate chamber or device, to the reduction reactor 2000 and is able to separate the combustion gases 310, also referred to as combustion flue gases, from the solid particles of the oxygen carrier in their most-reduced state 400. In the event of there being unburnt matter, which may arise if the hydrocarbon feedstock is solid, a solid/solid separation device able to separate the unburnt particles from the particles of the active mass may be employed at the outlet of the reduction reactor, as described later on in respect of other embodiments in connection with FIG. 5.

The particles of the oxygen carrier 400 that have passed through the reduction reactor 2000, and have been separated from the combustion gases, are sent to the cyclone oxidation reactor 3200 to be re-oxidized and separated.

The cyclone oxidation reactor 3200 comprises:
a cylindrical-conical chamber comprising a cylindrical upper portion surmounting an inverted frustoconical lower portion (the frustoconical portion is said to be inverted because the smallest-diameter cross section of the cone is in the lower part of the cylindrical-conical chamber and the largest-diameter cross section of the cone is in the upper part connected to the cylindrical upper portion, when the reactor is in operation),
an inlet pipe for admitting a gaseous mixture 120 containing particles of the oxygen carrier 400 and oxidizing gas 100, this inlet pipe comprising a main injection duct for the injection of oxidizing gas 100 and opening into the cylindrical upper portion of the chamber of the reactor,
an outlet pipe for a stream of oxygen-depleted gas 110, this pipe being positioned at the top of the cylindrical upper portion, and
a discharge pipe for discharging a stream of particles of oxygen carrier 102, this pipe being positioned at the bottom of the inverted frustoconical lower portion.

The reduced oxygen carrier 400 is advantageously mixed with a stream of oxidizing gas 100, typically air or steam, and preferably air, in an inlet pipe of the cyclone oxidation reactor. The stream of oxidizing gas is preferably sent via a main injection duct into the inlet pipe of the cyclone reactor, which pipe is connected to the outlet of the cyclone 3002, the circulation line between the cyclone 3002 and the inlet pipe of the cyclone reactor preferably comprising a gastight sealing device such as a trap, as depicted in FIG. 2.

The air that may be used as oxidizing gas is preferably made up of approximately 21% molecular oxygen and 78% molecular nitrogen (also conventionally referred to as “fresh” air). The remaining approximately 1% is made up predominantly of argon but also of other rare gases such as neon, krypton and xenon, as well as carbon dioxide in a content of around 0.04%.

The gas mixture 120 containing the oxygen carrier 400 is then sent into the cylindrical upper portion of the chamber of the cyclone oxidation reactor.

In the chamber of the cyclone oxidation reactor, the oxygen carrier is oxidized upon contact with the oxidizing gas 100 and the oxidized oxygen carrier is separated from the oxygen-depleted oxidizing gas 110, e.g. air that has been depleted as a result of the oxidation, and also referred to as depleted or impoverished air. The oxygen-depleted oxidizing gas 110 is discharged via the outlet pipe at the top of the cylindrical upper portion of the chamber, and a stream of oxidized oxygen carrier 102 is discharged via the discharge pipe in the bottom of the inverted frustoconical lower portion of the chamber.

The stream of particles of oxidized oxygen carrier 102 is transferred into the reduction reactor 2000. Advantageously, the line circulating the stream 102 comprises a sealing device, for example a trap.

What is meant by a depleted oxidizing gas (e.g. depleted air) is an oxidizing gas that is depleted in terms of oxygen content by comparison with an initial oxidizing gas (e.g. initial air or “fresh” air) prior to reaction in the oxidation zone. The depleted gas (e.g. depleted air) preferably contains less than 4% of molecular oxygen. The molecular-oxygen content of the depleted gas is dependent on the quantity of molecular oxygen initially contained in the initial oxidizing gas (approximately 21% in the case of fresh air) and on the superstoichiometric conditions applied to ensure maximum oxidation of all the particles of the oxygen carrier.

Typically, the depleted oxidizing gas (e.g. depleted air) contains approximately 2% of molecular oxygen. What is meant by approximately is to within plus or minus 0.5%. This is the result of preferably applying superstoichiometric conditions of the order of 10% in order to ensure sufficient oxidation of all the particles. These superstoichiometric conditions may be necessary in order to overcome limitations in the transfer between the oxygen and the particles and may vary according to the dynamics of the reaction with the oxygen carrier, and the hydrodynamics in the reactor.

The function of the cyclone oxidation reactor 3200 to oxidize the oxygen carrier is manifested in the fact that the latter becomes enriched with oxygen through reaction between the reduced form of the oxygen carrier and the molecular oxygen present in the oxidizing gas 100.

In the cyclone oxidation reactor 3200, the oxygen carrier is restored to its oxidized state MₓO_{y} upon contact with the oxidizing gas 100 (e.g. air or steam, and preferably air), according to reaction (2) below.

MₓO_{y-2n-m/2}+(n+m/4)O₂→MₓO_{y} [Math 2]

where n and m respectively represent the number of carbon and hydrogen atoms which have reacted with the oxygen carrier in the combustion reactor.

This reaction is dependent on the temperature, on the partial pressure of oxygen and also on the contact time of contact between the solid and the oxidizing gas. This contact time generally ranges between 1 second and 30 seconds.

The residence time that the oxygen carrier spends in the oxidation reactor is less than or equal to 30 seconds, preferably ranging between 1 s and 30 s, more preferentially ranging between 1 s and 20 s, and even more preferentially ranging between 1 s and 10 s.

The temperature in the cyclone oxidation reactor is generally between 600° C. and 1400° C., preferentially between 700° C. and 1000° C.

The oxygen carrier, passing alternately from its oxidized form in the cyclone oxidation reactor to its reduced form in the reduction reactor, and vice versa, describes a redox cycle.

The oxygen carrier can be composed of metal oxides, such as, for example, oxides of Fe, Ti, Ni, Cu, Mn, Co or V, alone or as a mixture, which can originate from ores (for example ilmenite, hematite or pyrolusite) or be synthetic (for example copper oxide particles supported on alumina, CuO/Al₂O₃, or nickel oxide particles supported on alumina, NiO/Al₂O₃, preferably copper oxide particles supported on alumina, CuO/Al₂O₃), with or without binder, and exhibits the required oxidation/reduction properties and the characteristics necessary for carrying out the fluidization.

Without this list being exhaustive, the oxygen carrier comprises at least one metal oxide which can be included in the list consisting of the oxides of Fe, Cu, Ni, Mn and/or Co, a perovskite having redox properties, (e.g. a perovskite of formula CaMnO₃, or a perovskite combining Mn, Ti and Fe) a metal aluminate spinel having redox properties, preferably a metal aluminate spinel of formula CuAl₂O₄ or of formula CuFe₂O₄.

The oxygen storage capacity of the oxygen carrier is advantageously, depending on the type of material, between 0.5% and 15% by weight. Advantageously, the amount of oxygen effectively transferred by the metal oxide is between 0.5% and 3% by weight, which makes it possible to use only a fraction of the total oxygen transfer capacity, ideally less than 30% of the latter, in order to limit the risks of mechanical aging or of agglomeration of the particles. The use of only a fraction of the oxygen transportation capacity also has the advantage that the fluidized bed acts as a thermal ballast and thus smooths the variations in temperature on the route of the oxygen carrier.

The oxygen carrier is in the form of fluidizable particles, belonging to groups A, B, C or D of the Geldart classification, preferably to groups A, B, or D, alone or in combination. Preferably, the particles of the oxygen carrier belong to group B of the Geldart classification. By way of example, and in a nonlimiting way, the particles of group B used exhibit a particle size such that more than 90% of the particles have a size of between 100 μm and 500 μm, preferably of between 150 μm and 300 μm.

Preferably, the particles of the oxygen carrier, which can be metal oxides, which are synthetic or natural ores, supported or not, have a density of between 1000 kg/m³ and 5000 kg/m³ and preferentially between 1200 kg/m³ and 4000 kg/m³.

For example, the nickel oxide particles supported on alumina (NiO/NiAl₂O₃) generally exhibit a grain density of between 2500 kg/m³ and 3500 kg/m³, depending on the porosity of the support and on the nickel oxide content, typically of approximately 3200 kg/m³.

Ilmenite, an ore combining titanium and iron (titanium and iron oxide: FeTiO₃), has a density of 4700 kg/m³.

The oxygen carrier can undergo a phase of activation so as to increase its reactive capacities, which may consist of a phase of rise in temperature, preferably a gradual one, preferably under an oxidizing atmosphere (for example under air).

As a preference, the oxygen carrier has the property of oxidizing rapidly under the conditions employed in the cyclone oxidation reactor, notably under the temperature conditions employed. As a preference, a level of oxidation of the oxygen carrier (i.e. the ratio between the oxidized mass and the active mass) ranging between 55% and 95% is achieved in the cyclone oxidation reactor in 30 seconds or less, preferably 20 seconds or less, and more preferentially 10 seconds or less. Oxygen carriers suitable for such rapid oxidation are, for example and nonlimitingly, particles of perovskite (a perovskite having redox properties, for example a perovskite that combines Mn, Ti and Fe), particles of copper oxide supported on alumina, manganese ore, hematite, ilmenite, etc. According to one or more embodiments, the carrier used comprises particles of perovskite, of copper oxide supported on alumina, or of manganese ore.

The cyclone structure of the oxidation reactor is preferably that of a conventional cyclone of the tangential-inlet reverse-flow cyclone type. In this type of cyclone, the gas mixture containing solid particles enters the cyclone at the top and is subjected to a centrifugal movement as a result of being admitted tangentially. The particles are propelled toward the wall of the cyclone by the centrifugal force and then drop down along the wall under the effect of gravity. At the bottom of the cyclone, in the inverted frustoconical section, the stream of gas, rid of the particles that are discharged at the bottom of the frustoconical section, reverses direction to form an internal vortex which leaves the cyclone via an axial duct at the top of the cyclone. In the cyclone oxidation reactor according to the invention, the outlet pipe for the stream of oxygen-depleted gas 110 is preferably situated along the axis of the cylindrical-conical chamber of the reactor, and may comprise an internal cylindrical part over a height h, generally referred to as the “vortex finder” as is conventional in a reverse-flow cyclone.

The function of the cyclone oxidation reactor 3200 of separating the oxidized oxygen carrier from the oxygen-depleted oxidizing gas, while performing oxidation, is ensured through the cyclone structure of the reactor, and leads to the production of the stream of oxygen-depleted gas 110 which leaves the reactor at the top of the cylindrical upper portion of the reactor chamber, and the stream of particles of oxygen carrier 102 discharged from the bottom of the inverted frustoconical lower portion of the reactor chamber.

The gas/solid mixture 120 that enters the cyclone reactor produces a spinning movement as a result of centrifugal force. This movement produces several spirals in the cylindrical upper part of the cylindrical-conical chamber (also commonly known as the “barrel” of a cyclone) before separating the gas, which leaves via the outlet pipe at the top of the chamber, from the solid which collects at the bottom of the chamber. The number of spirals travelled by the gas/solid mixture in the cyclone reactor is dependent on the inlet and outlet velocities and on the concentration of the solid in the gas. For the same gas inlet and outlet geometry, the separation efficiency of the cyclone reactor remains the same while the residence time that the solid spends in the cyclone reactor can be adapted as required by designing a cyclone reactor of greater diameter and height. A greater diameter of the cyclone reactor increases the perimeter travelled by the spiral of solid matter and makes it possible to obtain the residence time required for achieving the oxidation reaction.

As a preference, the inlet pipe of the cyclone oxidation reactor may have a rectangular cross section.

The inlet pipe of the cyclone oxidation reactor may also be equipped with at least one secondary oxidizing-gas injection duct 100 (not depicted in FIG. 2), preferably situated on a lower wall of the inlet pipe. This or these secondary injection duct(s) enable(s) oxidizing gas to be injected in such a way as to disperse the solid particles of the oxygen carrier and limit the risk of solid particles being deposited in the inlet pipe. Such a risk may also be limited through the use of an inlet pipe of which the lower wall is inclined with respect to the horizontal by an angle α greater than the angle of repose of the solid particles. The angle α preferably has an absolute value ranging between α′ and α′+45°, preferably ranging between α′+10° and α′+20°, α′ being the angle of repose of the particles. The angle of repose or natural slope angle α′ of the particles is traditionally defined as being the angle between the gradient of the heap of uncompacted powder and the horizontal direction and may be determined in various ways. For example, this angle may be measured by pouring powder through a funnel so as to form a small heap of product characterized by a gradient with respect to the horizontal surface. The angle of repose may also be measured by sliding a solid along an inclined plane, the angle of repose then being measured as the angle at which the solid material begins to slide, or by using a rotary cylinder to determine the angle that allows the solid to flow. These last two methods are preferably used to determine the angle of repose because they involve movement of the solid. The angle α of inclination of the lower wall of the inlet pipe may have an absolute value ranging between 5° and 80°, preferably between 15° and 60°, more preferably between 15° and 45°, and more preferably still between 20° and 45°.

The downward inclination of the lower wall of the inlet pipe encourages the solid particles to flow and re-accelerate toward the chamber of the cyclone reactor, reducing the particle saltation speed, and, therefore, the build-up of particles, and the secondary injection duct or ducts enable(s) the injection of the oxidizing gas, in an auxiliary manner to the main injection, so as to disperse the solid particles. In particular, this makes it possible to reorientate the solid particles that fall onto the lower wall toward the main stream of gas in the inlet pipe, and destroy any build-up of particles there might be. For example, the flowrate of oxidizing gas sent in an auxiliary manner via the secondary injection ducts ranges between 0.1% and 30% by volume of the flowrate of oxidizing gas injected by the main injection duct and used for oxidizing the oxygen carrier in the cyclone reactor, or even between 1% and 10% by volume.

Through reduced accumulation of solid particles in the inlet pipe, obstruction of the inlet to the cyclone reactor is avoided, so disturbance to the cyclone operation of the reactor and therefore to correct gas/solid separation is avoided. The dispersal of the solid particles in the main stream of gas allows a maximum quantity of particles to be carried into the chamber of the cyclone oxidation reactor, thereby enabling better gas/solid separation than is achieved if these same particles are allowed to stagnate and build up in the pipe.

The number of secondary injection ducts is dependent on the total flowrate of oxidizing gas supplementarily injected, and the lower wall of the pipe may for example have between 1 and 10, preferably between 2 and 5, secondary injection ducts per square meter.

The secondary injection duct or ducts is/are preferably configured to form a jet that makes an angle ranging between 0° and 90°, preferably greater than 0° and less than 90°, and more preferentially ranging between 0° (and preferably greater than 0°) and 45°, with respect to the horizontal axis, in a vertical plane. The jet formed is thus preferably directed toward the axis of flow of the gas/solid mixture in the pipe, so as not to cause excessive disturbance of the stream heading toward the chamber of the cyclone oxidation reactor.

Advantageously, the secondary injection duct or ducts may be configured in such a way that the velocity of the gas leaving said duct(s) ranges between 5 m/s and 100 m/s, preferably between 20 m/s and 40 m/s, so as to prevent solid particles from entering the secondary injection duct, so as to obtain good dispersal of the solid particles and break up any agglomerations without creating attrition.

As a preference, the inlet pipe may have a cross section at the inlet to the reactor chamber that is such that the superficial gas velocity of the gaseous gas/solid mixture leaving said inlet pipe and entering the chamber is between 5 m/s and 35 m/s, and more preferentially between 15 m/s and 25 m/s, in order to achieve good separation performance.

Advantageously, the cross-sectional areas of the inlet pipe at its two ends may be equal, and therefore the superficial gas velocities connected therewith may also be equal. In this way, it is possible to limit the erosion of the cyclone reactor and the attrition of the particles that is associated with heavy impact against the walls of the cyclone, which is something that could occur if the velocity of the gas were to increase. This is for example possible if the inlet pipe with an inclined lower wall also has a vertical lateral wall that is inclined by a defined angle β in the horizontal plane such that the cross sections at the ends have the same cross-sectional area or even so that the cross-sectional area remains constant all along the inlet pipe. The angle β may have an absolute value of between 5° and 70°, preferably between 10° and 50°.

According to the invention, the cyclone oxidation reactor is operated under the temperature conditions of the CLC method as detailed hereinabove. It is thus preferably made from materials suited to the high temperatures encountered in CLC, typically ranging between 700° C. and 1000° C., or even between 600° C. and 1400° C., for example, and nonlimitingly, high-temperature steels such as those of the Hastelloy®, Incoloy®, Inconel® or Manaurite® type, or conventional steels, for example of stainless steel or carbon steel type, combined with refractory materials or combined with cooling means, such as tubes in which a heat-exchange fluid circulates.

The cyclone oxidation reactor is well suited to gas/solid separation of gas/solid mixtures containing solid particles with a mean particle diameter ranging between 20 μm and 1000 μm. In particular, the cyclone oxidation reactor is well suited to gas/solid separation of gas/solid mixtures containing solid particles of the size described more for the oxygen carrier, having a particle size such that more than 90% of the particles have a size of between 100 μm and 500 μm, preferably of between 150 μm and 300 μm.

The cyclone oxidation reactor is well suited to the gas/solid separation of gas/solid mixtures containing a solid-particles content that preferably ranges between 0.1 and 50 wt/wt (weight of solid particles with respect to weight of gas).

According to one or more variants which have not been depicted, the CLC plant may comprise several cyclone oxidation reactors configured to operate in parallel, oxidation of the oxygen carrier in this case then being performed in parallel in the various cyclone oxidation reactors. The CLC plant then comprises means for distributing the oxygen carrier and for supplying oxidizing gas to the various cyclone oxidation reactors, as well as means for collecting the oxidized oxygen carrier coming from the various oxidation reactors and returning it to the reduction reactor 2000. Such a layout makes it possible to conform to constraints regarding a maximum equipment size not to be exceeded, or a constraint on the installation space available on the site of the CLC plant.

The CLC plant according to the invention, particularly the cyclone oxidation reactor, makes it possible to reduce the residence time spent by the oxygen carrier in the “air” circuit (the sections in which the oxygen carrier is in contact with the air) by half in comparison with a conventional layout of an air reactor associated with a cyclone, without this resulting in any loss of performance.

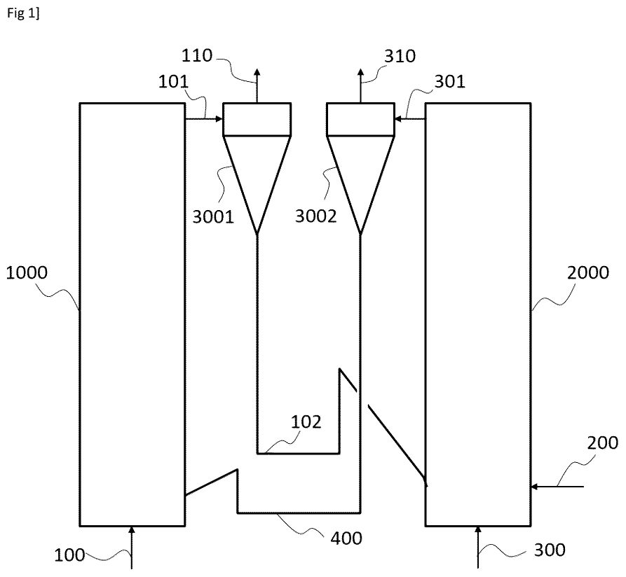

Moreover, the CLC plant according to the invention is more compact in comparison with the conventional CLC layout as shown in FIG. 1, and the capital expenditure (CAPEX) can be not as high on account of the savings on equipment.

One advantage associated with the invention also lies in the possibility of converting existing industrial combustion units, typically comprising a boiler, which can be converted to a fuel reactor and fitted with a cyclone oxidation reactor as described in order to form a CLC plant.

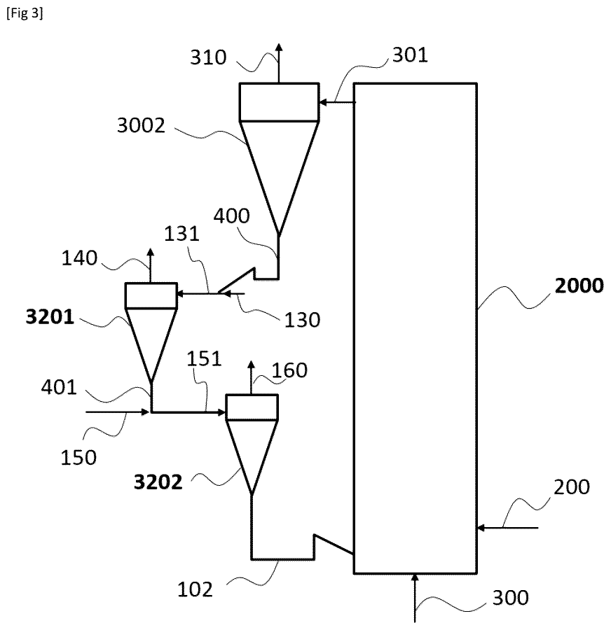

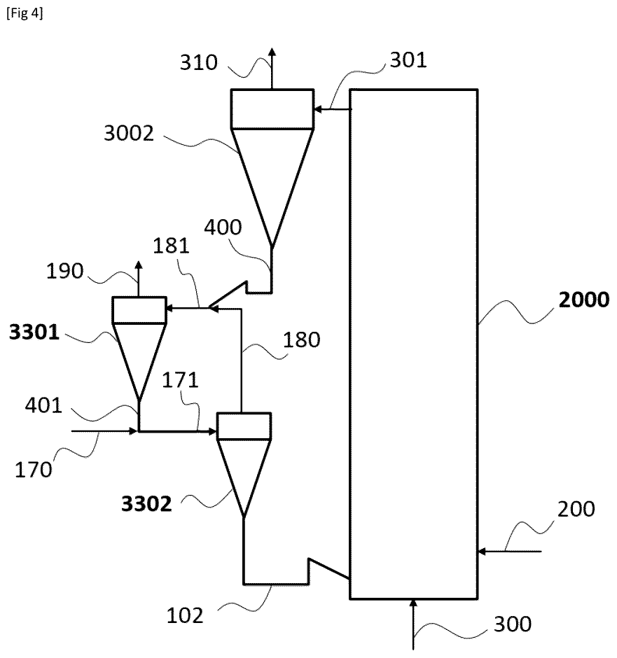

According to one or more variants which have not been depicted, the CLC plant comprises several cyclone oxidation reactors configured to operate in series. Examples are illustrated in FIGS. 3 and 4 and described hereinbelow.

FIG. 3 depicts a CLC plant according to one or more embodiments of the present invention comprising two successive cyclone oxidation reactors, and the operation thereof. The CLC plant and the operation thereof are identical to that described in connection with FIG. 2 in every respect, except for the oxygen carrier oxidation part, which is detailed hereinbelow. Nevertheless, the principle of the oxidation of the oxygen carrier, the nature of the reagents, the temperature conditions, the structure of the cyclone oxidation reactor, the materials used for the reactors, are identical to those described in connection with FIG. 2 and are not repeated here.

According to this or these embodiments, the CLC plant and method comprise staged oxidation: the oxidation reaction of the oxygen carrier is broken down into n successive steps, for example into two steps each employing a dedicated cyclone oxidation reactor, the two cyclone oxidation reactors operating in series, as depicted in FIG. 3.

In each of these oxidation steps, the oxygen carrier is mixed with an oxidizing gas and carried along by an oxidizing-gas flowrate equivalent to 1/n of the oxidizing-gas flowrate needed for full oxidation of the oxygen carrier.

The stream of reduced oxygen carrier 400 is introduced into the inlet pipe of a first cyclone oxidation reactor 3201 where it is mixed with a first stream of oxidizing gas 130, which results in a first gas/solid mixture 131 which is introduced into the first cyclone oxidation reactor 3201, operating in an identical way to that described in connection with FIG. 1, except that the separated oxygen carrier discharged from said first reactor is partially oxidized and the oxidation thereof is completed in a second cyclone oxidation reactor 3202. The operation of the first cyclone oxidation reactor 3201 results in a stream of depleted oxidizing gas 140 which is discharged via an outlet pipe at the top of the chamber of the first reactor 3201, and a stream of partially oxidized oxygen carrier 401 which is discharged via the discharge pipe of the first reactor 3201. The stream of partially oxidized oxygen carrier 401 is sent to the inlet pipe of the second cyclone reactor 3202 where it is mixed with a second stream of oxidizing gas 150 to form a second gas-solid mixture 151 which is introduced into the second cyclone oxidation reactor 3202. The oxidation of the carrier is therefore completed in the chamber of this second cyclone oxidation reactor 3202, resulting in a second stream of depleted gas 160 which is discharged via an outlet pipe at the top of the chamber of the second reactor 3202, and a stream of oxidized oxygen carrier 102 which is discharged via the discharge pipe of the second reactor 3202, bound for the reduction reactor 2000.

The embodiment or embodiments depicted in FIG. 3 has/have the advantage of allowing oxidation of the oxygen carrier while at the same time conforming to a constraint regarding a maximum equipment size not to be exceeded, or a constraint on the installation space available on the site of the CLC plant.

FIG. 4 depicts a CLC plant according to one or more embodiments of the present invention comprising two successive cyclone oxidation reactors, the first of which is fed with an oxygen-depleted oxidizing gas coming from the second oxidation reactor, and depicts the operation thereof. The CLC plant and the operation thereof are identical to that described in connection with FIG. 2 in every respect, except for the oxygen carrier oxidation part, which is detailed hereinbelow. Nevertheless, the principle of the oxidation of the oxygen carrier, the nature of the reagents, the temperature conditions, the structure of the cyclone oxidation reactor, the materials used for the reactors, are identical to those described in connection with FIG. 2 and are not repeated here.

According to this or these embodiments, the CLC plant and method comprise staged oxidation like that illustrated in FIG. 3, comprising n oxidation steps, except that what the oxygen carrier in its most reduced step is brought into contact with is an oxygen-depleted oxidizing gas coming from a downstream oxidation stage. Here again the oxidation is performed in n successive steps, for example in two steps each employing a dedicated cyclone oxidation reactor, the two cyclone oxidation reactors operating in series, as depicted in FIG. 4, but unlike in the oxidation illustrated in FIG. 3, the stream of oxygen-depleted gas from the second cyclone oxidation reactor is used as oxidizing gas sent into the main injection duct of the inlet pipe of the first cyclone reactor. In instances in which n is greater than 2, each stage is fed with depleted air coming from the cyclone oxidation reactor downstream of it. Only the last cyclone oxidation reactor is fed with fresh air: it is these last few percent of oxidation level that are the most difficult to obtain, and fresh air, which is rich in molecular oxygen, is therefore advantageously used in the reactor furthest downstream. In each of these oxidation steps, the oxygen carrier is mixed with an oxidizing gas and carried along by an oxidizing-gas flowrate equivalent to 1/n of the oxidizing-gas flowrate needed for full oxidation of the oxygen carrier.

According to this or these embodiments, the oxidizing-gas flowrate needed for full oxidation preferably corresponds to the fresh air flowrate 150 in the last cyclone oxidation reactor. Each cyclone oxidation reactor (from the penultimate to the first) preferably receives an increasingly lower flowrate of oxidizing gas, because the O₂ is progressively being depleted.

The stream of reduced oxygen carrier 400 is introduced into the inlet pipe of a first cyclone oxidation reactor 3301 where it is mixed with the stream of gas 180 produced in a second cyclone oxidation reactor 3302, which results in a first gas/solid mixture 181 which is introduced into the first cyclone oxidation reactor 3301, operating in an identical way to that described in connection with FIG. 1, except that the separated oxygen carrier discharged from said first reactor is partially oxidized and the oxidation thereof is completed in a second cyclone oxidation reactor 3302. The operation of the first cyclone oxidation reactor 3301 results in a stream of depleted oxidizing gas 190 which is discharged via an outlet pipe at the top of the chamber of the first reactor 3301, and a stream of partially oxidized oxygen carrier 401 which is discharged via the discharge pipe of the first reactor 3301. The stream of partially oxidized oxygen carrier 401 is sent to the inlet pipe of the second cyclone reactor 3302 where it is mixed with a stream of fresh oxidizing gas 170 (e.g. fresh air) to form a second gas-solid mixture 171 which is introduced into the second cyclone oxidation reactor 3302. The oxidation of the carrier is then completed in the chamber of this second cyclone oxidation reactor 3302, resulting in two streams:
the stream of gas 180 discharged by an outlet pipe at the top of the chamber of the second reactor 3202, said outlet pipe being connected to the inlet pipe of the first cyclone oxidation reactor 3301 to form the main injection duct injecting oxidizing gas into the first inlet pipe, and
the stream of oxidized oxygen carrier 102 discharged by the discharge pipe of the second reactor 3302 and bound for the reduction reactor 2000.

The embodiment or embodiments depicted in FIG. 4 has/have the advantage of allowing oxidation of the oxygen carrier while at the same time conforming to a constraint regarding a maximum equipment size not to be exceeded, or a constraint on the installation space available on the site of the CLC plant. Another advantage of this layout lies in the possibility of reducing the contact time needed for oxidation of the oxygen carrier: specifically, the oxygen carrier is brought into contact with the most oxygen-depleted oxidizing gas in a state in which this carrier is at its most reduced and therefore its most “active” in terms of the potential for oxidizing it. As a result, the residence time needed in order to achieve a given state of oxidation is shorter than in a co-current arrangement such as that of the prior art or that of FIG. 3.

FIG. 5 depicts a CLC plant and operation thereof according to one or more embodiments of the present invention highly suitable for the combustion of a solid hydrocarbon feedstock, comprising a cyclone oxidation reactor and a solid/solid separation device at the outlet of the reduction reactor.

In the case of combustion of solid feedstocks, the CLC plant may in fact comprise:
a solid/solid separator 3100, as already mentioned above, positioned downstream of and connected directly, i.e. without any other intermediate device or chamber, to the reduction reactor 2000, configured to operate as a fluidized bed, to receive a gas/solid mixture 301 coming from said reduction reactor 2000, and to perform separation between the particles of the reduced oxygen carrier 440 and unburnt particles contained in the gas/solid mixture 310, and
at least one cyclone 3002 positioned downstream of the solid/solid separation device 3100 and configured to receive a stream of gas 601 containing the unburnt particles and to perform separation between the unburnt particles and the combustion flue gases 610, the cyclone 3002 preferably comprising an outlet pipe for the unburnt particles 602, which pipe is connected to the reduction reactor 2000.

The stream of oxygen carrier 102 is conveyed into the reduction reactor 2000 fluidized by a fluidizing gas 300 where it will react with the solid hydrocarbon feedstock 201 of which the single-pass conversion may be incomplete, necessitating several passes through the reduction reactor with the unconverted fraction of the feedstock being recycled. The solid/solid separator 3100 is able to separate the reduced oxygen carrier 440 from a stream of gas 601 containing combustion gases, fluidizing gas, an unconverted solid fraction of the feedstock referred to as unburnt particles, and a minority fraction of oxygen carrier. The stream of gas 601 containing solid particles is separated in the cyclone 3200 which discharges a stream 610 containing the combustion flue gases (and also containing part of the fluidizing gas) and, on the other hand, a stream 602 containing the unconverted fraction of the feedstock (the unburnt particles) and a minority fraction of the oxygen carrier, these preferably being conveyed back to the reduction reactor 2000.

The stream of reduced oxygen carrier 440 is preferably extracted from the solid/solid separator 3100 by means of an L-ported valve 4000, which is a device providing control of the stream of oxygen carrier that passes through it as a function of the fraction of oxidizing gas 100, e.g. air, that is introduced into the vertical part of the L-ported valve. The rest of the oxidizing gas, e.g. air, may be introduced into the horizontal part of the L-ported valve so as to form and transport the gas-solid mixture 115 toward the cyclone oxidation reactor 3400 where the oxygen carrier is oxidized and the gas/solid is separated both as described in connection with FIG. 2, resulting in two streams: a stream of depleted oxidizing gas 116, e.g. depleted air; and a stream of oxidized oxygen carrier 102 headed for the reduction reactor 2000.

Other cyclones similar to the cyclone 3002 may be positioned downstream of the cyclone 3002, for more rigorous gas/solid separation.

The solid/solid separator 3100 is used to separate the unburnt particles from the particles of the oxygen carrier on the basis of the different physical properties of size and density of the particles. Specifically, the particles of the oxygen carrier, described above, generally have a far greater size and density than the unburnt particles and also than the fly ash coming from the reduction reactor.

The solid/solid separator 3100 may thus be used to separate, on the one hand, unburnt particles and, on the other hand, particles of the oxygen carrier having a density greater than or equal to 1000 kg/m³, preferably greater than or equal to 1200 kg/m³, more preferentially greater than or equal to 2500 kg/m³. Typically, more than 90% of the particles of the oxygen carrier have a size of between 100 μm and 500 μm, preferably of between 150 μm and 300 μm. At the outlet of the reduction reactor, it is estimated that the size of the unburnt particles is less than 100 μm and that the majority of said unburnt particles have a size of between 20 μm and 50 μm. The density of these unburnt particles is in general between 1000 and 1500 kg/m³.

Other particles, such as the fly ash, as distinct from the unburnt particles, and resulting from the combustion of the solid feedstock, may also circulate with the remainder of the particles, and are characterized by a particle size and density that are lower than the particles of oxygen carrier (i.e. less than 100 μm), and often also lower than the unburnt particles. The ash is formed of noncombustible elements resulting from the complete combustion of the particles of solid fuel and for which the residence time in the combustion reactor has been sufficient. The ash is mainly inorganic in nature. It typically comprises the following compounds: SiO₂, Al₂O₃, Fe₂O₃, CaO, MgO, TiO₂, K₂O, Na₂O, SO₃, P₂O₅. If ash is present in the method and, in particular, in the gas mixture coming from the reduction reactor, it may be separated out and carried along with the unburnt particles in the solid/solid separator 3100.

Such a solid/solid separator is known and described for example in international application WO2011151535. It preferably comprises a chamber with an inlet pipe admitting the gas/solid mixture 301 opening into a dilute phase at the upper part of the chamber, a discharge pipe situated in the lower part of the chamber and an outlet pipe situated in the upper part of the chamber. The inlet and discharge/outlet parameters are chosen to create within the chamber a dense phase in the lower part and the dilute phase in the upper part (solid content generally less than 5% or even 1%). In the solid/solid separator, the superficial velocity of the gas flow is advantageously greater than the terminal velocity of falling of the unburnt particles so as to allow these to be entrained with the gas, thus allowing “rapid” separation to be performed to separate the heavy (oxygen carrier) particles from the light particles (unburnt particles). The term “rapid separation” means a separation taking place in less than 1 minute and preferentially in less than 20 seconds, this duration corresponding to the residence time of the light particles in the dilute phase of the separator.

Whereas numerous features have been described in the various embodiments presented, it will be obvious to a person skilled in the art that these features may be combined in any possible combination. By way of example, the embodiment or embodiments described in connection with FIG. 5 may comprise several cyclone oxidation reactors as described in connection with FIGS. 3 and 4.

### Example

The following example seeks to illustrate certain performance aspects of an example cyclone oxidation reactor of the CLC plant according to the invention, particularly the oxidation and separation that may be performed in the cyclone oxidation reactor.

The cyclone oxidation reactor exemplified is as described in connection with FIG. 2 and has the main features listed in table 1 below.

TABLE 1

| | | |
|---|---|---|
| Diameter of cyclone reactor (barrel) | meters | 2.4 |
| Inlet height (rectangular cross section of the intake pipe) | meters | 1.4 |
| Inlet width | meters | 0.6 |
| Cyclone reactor height (cylindrical-conical chamber) | meters | 12 |
| Vₒᵤₜ gas (m/s) | m/s | 35.0 |
| Number of spirals | — | 5.2 |
| Flowrate of solid | kg/s | 65 |
| Temperature of solid at the inlet | ° C. | 830 |
| Flowrate of air at 21 mol % O₂ | kg/s | 5 |
| Temperature of air at the inlet | ° C. | 40 |
| Residence time for solid | s | 8.7 |

Such a cyclone oxidation reactor is able for example to oxidize oxygen carriers of the ilmenite, manganese ore, iron ore, perovskite, copper oxide on alumina type entering the reactor at a level of oxidation of 55% to a level of oxidation greater than or equal to 90%, as indicated in table 2 below.

TABLE 2

| | Level of oxidation on |
|---|---|
| | leaving the reactor |
| Ilmenite | 90% |
| Manganese ore | 91% |
| Perovskite of formula CaMn_{0.375}Ti_{0.5}Fe_{0.125}O₃ | 100% |
| Tierga iron ore (hematite) | 95% |
| CuO at 10 wt % on Al₂O₃ | 100% |

Such a cyclone oxidation reactor also enables solid particles of the oxygen carrier to be separated from the depleted air.

For particles of a mean diameter of 250 microns (particle size between 160 and 475 microns) and of density 2500 kg/m³, 100% gas/solid separation is achieved with an air flowrate of 5 kg/s and an inlet velocity of 20 m/s.

1. A chemical looping combustion plant for the combustion of a hydrocarbon feedstock using a solid-state oxygen carrier in the form of particles, comprising at least:
a reduction reactor (2000) configured to operate as a fluidized bed and perform the combustion of said hydrocarbon feedstock (200, 201) in contact with said oxygen carrier (102);
at least one cyclone oxidation reactor (3200, 3201, 3202, 3301, 3302, 3400) configured to oxidize said reduced oxygen carrier (400, 440) coming from said reduction reactor by bringing it into contact with an oxidizing gas (100, 130, 150, 180) and to separate said oxidized oxygen carrier from said oxygen-depleted oxidizing gas (110, 140, 160, 180, 190, 116);
lines for circulating said oxygen carrier between said reduction reactor (2000) and said at least one cyclone oxidation reactor (3200, 3201, 3202, 3301, 3302, 3400).

2. The plant as claimed in claim 1, wherein said at least one cyclone oxidation reactor comprises:
a cylindrical-conical chamber comprising a cylindrical upper portion surmounting an inverted frustoconical lower portion;
an inlet pipe carrying a gaseous mixture containing particles of the oxygen carrier and oxidizing gas, said inlet pipe being equipped with a main injection duct for the injection of oxidizing gas (100, 130, 150, 180) and said inlet pipe opening into said cylindrical upper portion;
an outlet pipe for a stream of oxygen-depleted gas, this pipe being positioned at the top of the cylindrical upper portion;
a discharge pipe for discharging a stream of particles of oxygen carrier, this pipe being positioned at the bottom of the inverted frustoconical lower portion.

3. The plant as claimed in claim 1, comprising several cyclone oxidation reactors configured to operate in series and/or in parallel.

4. The plant as claimed in claim 3, comprising two cyclone oxidation reactors (3201, 3202, 3301, 3302) configured to operate in series.

5. The plant as claimed in claim 3, comprising at least two cyclone oxidation reactors configured to operate in series, and wherein the outlet pipe of a second cyclone oxidation reactor (3302) positioned downstream of a first cyclone oxidation reactor (3301) is connected to the inlet pipe of said first cyclone oxidation reactor (3301) to form the main injection duct for the injection of oxidizing gas (180) fed to said first cyclone oxidation reactor (3301).

6. The plant as claimed in claim 1, wherein the inlet pipe of said at least one cyclone oxidation reactor is equipped with at least one secondary oxidizing-gas injection duct, preferably situated on a lower wall of said inlet pipe.

7. The plant as claimed in claim 1, comprising a cyclone (3002) positioned downstream of and connected directly to said reduction reactor (2000), configured to receive a gas/solid mixture (301) coming from said reduction reactor (2000) and to perform separation between the reduced oxygen carrier (400) and combustion flue gases (310), said cyclone (3002) comprising an outlet pipe for the reduced oxygen carrier (400), this pipe being connected to said at least one cyclone oxidation reactor (3200, 3201, 3301).

8. The plant as claimed in claim 1, comprising:
a solid/solid separation device (3100) positioned downstream of and connected directly to said reduction reactor (2000), said solid/solid separation device (3100) being configured to operate as a fluidized bed, to receive a gas/solid mixture (301) coming from said reduction reactor (2000), and to perform separation between the particles of the reduced oxygen carrier (440) and unburnt particles contained in said gas/solid mixture, and
at least one cyclone (3002) positioned downstream of said solid/solid separation device (3100) and configured to receive a stream of gas (601) containing said unburnt particles and to perform separation between said unburnt particles and combustion flue gases (610), said cyclone (3002) preferably comprising an outlet pipe for said unburnt particles, which pipe is connected to said reduction reactor (2000).

9. A chemical looping combustion method for the combustion of a hydrocarbon feedstock using a solid-state oxygen carrier in the form of particles, wherein:
the hydrocarbon feedstock is burnt by bringing it into contact with the oxygen carrier in a reduction reactor (2000) operating as a fluidized bed;
the oxygen carrier that has passed through the reduction reactor (2000) is oxidized by bringing it into contact with an oxidizing gas (100, 130, 150, 180), preferably air, in at least one cyclone oxidation reactor (3200, 3201, 3202, 3301, 3302, 3400), and said oxidized oxygen carrier and the oxygen-depleted oxidizing gas are separated in said cyclone oxidation reactor before said oxidized oxygen carrier is returned to the reduction reactor (2000).

10. The method as claimed in claim 9, wherein:
an oxidizing gas (100) and the oxygen carrier (400, 440) coming from the reduction reactor (2000) are mixed in an inlet pipe of said at least one cyclone oxidation reactor;
said gaseous mixture (120, 131, 181, 115) containing the oxygen carrier is sent into a cylindrical upper portion of a cylindrical-conical chamber of said cyclone oxidation reactor, said cylindrical-conical chamber comprising the cylindrical upper portion surmounting an inverted frustoconical lower portion;
said oxygen carrier is oxidized in contact with the oxidizing gas and the oxidized oxygen carrier and the oxygen-depleted oxidizing gas are separated within said cylindrical-conical chamber;
said oxygen-depleted oxidizing gas (110, 140, 190, 116) is discharged via an outlet pipe positioned at the top of the cylindrical upper portion;
and a stream of oxidized oxygen carrier (102, 401) is discharged via a discharge pipe positioned at the bottom of the inverted frustoconical lower portion.

11. The method as claimed in claim 10, wherein the oxygen carrier (400, 440) coming from the reduction reactor (2000) is oxidized in two cyclone oxidation reactors (3201, 3202, 3301, 3302) operating in series and/or in parallel.

12. The method as claimed in claim 11, wherein the oxygen-depleted oxidizing gas discharged via the outlet duct of a second cyclone oxidation reactor (3302) positioned downstream of a first cyclone oxidation reactor (3301) is used to form the gaseous mixture in the inlet pipe of said first cyclone oxidation reactor (3301) and to oxidize the oxygen carrier (400, 440) coming from the reduction reactor (2000) within said first cyclone oxidation reactor (3301).

13. The method as claimed in claim 9, wherein a gas/solid mixture (301, 601) coming from the reduction reactor (2000) is sent to a cyclone (3002) positioned downstream of and connected directly to said reduction reactor (2000) in order to separate the reduced oxygen carrier (400) from the combustion flue gases (310) contained in said gas/solid mixture, and the reduced oxygen carrier (400) is sent to said at least one cyclone oxidation reactor (3200, 3201, 3301).

14. The method as claimed in claim 9, wherein the hydrocarbon feedstock is a solid feedstock in the form of particles (201), preferably selected from the list consisting of coal, coke, petcoke, biomass, oil sands and household waste, and wherein:
a gas/solid mixture (301) coming from the reduction reactor (2000) is sent to a solid/solid separation device (3100) connected directly to said reduction reactor (2000) and operating as a fluidized bed in order to separate the reduced oxygen carrier (440) from the unburnt particles contained in said gas/solid mixture;
a stream of gas (601) coming from the solid/solid separator and containing said unburnt particles is sent to at least one cyclone (3002) in order to separate said unburnt particles (602) from the combustion flue gases (610);
the reduced oxygen carrier (440) is sent to said at least one cyclone oxidation reactor (3400), preferably by means of an L-ported valve (4000);
optionally, said unburnt particles (602) are sent to said reduction reactor (2000).

15. The method as claimed in claim 9, wherein the residence time of the oxygen carrier in said at least one oxidation reactor is less than or equal to 30 seconds.
